(19) United States
(12) Patent Application Publication
(10) Pub. No.: US 2008/0102422 A1
(43) Pub. Date: May 1, 2008

(54) Method of and systems for business and narrative development

(76) Inventors: Marcus Perry Hayes, Abingdon (GB); Paul Anthony Honeywell, Spratton (GB); Christopher John Spencer, Gloucestershire (GB); Helene Fokdal Spencer, Gloucestershire (GB); Alison Ruth Esse, Didcot (GB)

Correspondence Address: Breiner & Breiner, L.L.C., P.O. Box 320160, Alexandria, VA, 22320-0160, US

(21) Appl. No.: 11/907,992

(22) Filed: Oct. 19, 2007

Related U.S. Application Data
(60) Provisional application No. 60/853,026, filed on Oct. 20, 2006.

(51) Int. Cl. G09B 19/00

(52) U.S. Cl. 434/107

(57) ABSTRACT

A method and system of business development are disclosed. The method and system of business development include formulating a forward strategy by one or more individuals, formulating that strategy into a narrative structure and providing a graphic representation of that narrative structure. The method and system further include developing by way of group discussion the narrative for the strategy and tailoring parts of the narrative to particular individuals or groups of employees' responsibilities. The method and system further include disseminating the narrative or sub-portions of the narrative to relevant persons or groups of persons within the organization, and promoting narrative feedback from those individuals or groups of individuals relative to the implementation of the strategy in question.

### RELATED APPLICATION

This application claims benefit of U.S. provisional application Ser. No. 60/853,026, filed Oct. 20, 2006, entitled METHOD OF AND SYSTEMS FOR BUSINESS AND NARRATIVE DEVELOPMENT.

### FIELD OF INVENTION

This invention relates to a method and system of business development and in particular to the use of modern communications systems and communications strategies to best effect to enable business, especially larger organizations, better to develop and implement complex strategies.

### BACKGROUND OF INVENTION

The invention may be practiced among employees of a single organization, though the invention can also apply to, for example, a group of organizations cooperating or collaborating in a particular project or business venture, for example operating a consortium.

A well-recognized problem in running a business of above a relatively small size is to ensure that the individuals working in the business know what is going on. It is well understood that enhanced knowledge and understanding of the objectives of the business and the way it operates can have beneficial effects, both internally in terms of employee satisfaction and more objectively in terms of improved performance, and profitability. In particular, the success or failure of a complex strategy may depend on its implementation and, in particular, on the degree of involvement with and understanding of the strategy in question by individuals in an organization.

### SUMMARY OF INVENTION

The invention includes a method and system for promoting business development within organizations by promoting interaction between individuals who work in such organizations, particularly using modern communications infrastructure.

The underlying approach to business and individual development for the present invention is based on the well-established phenomenon that information is more easily absorbed, more likely to be remembered, and more effectively transmitted if the information is put into a narrative or story form.

According generally to the present invention, a method of business development comprises the formulation of a forward strategy by one or more individuals, formulating that strategy into a narrative structure, providing a graphic representation of that narrative structure, developing by way of group discussion the narrative for the strategy, tailoring parts of the narrative to particular individuals or groups of employees, responsibilities, disseminating the narrative or sub-portions of the narrative to relevant persons or groups of persons within the organization, and promoting narrative feedback from those individuals or groups of individuals relative to the implementation of the strategy in question.

By operating in this way, it is possible to secure vigorous and effective development and implementation even of complex strategies, and to do so in organizations which have not previously had effective internal communications systems. A part of the effectiveness stems from the willingness of individuals to tell stories to others, this willingness being largely independent on whether the stories are fictional narratives, i.e., what might be hoped for, or historical narratives, i.e., what has actually been achieved or done.

In putting the method and system of the invention into effect, there are accordingly a number of phases following the initial formulation of a strategy, e.g. by senior management. These phases include initial engagement, building the story and creating the living story. Each phase has a set of predetermined tools and storytelling techniques.

The first step is to convert complex strategy into a simple and compelling journey—the StoryMap. This is a framework which, in clear and simple language, helps people learn about and understand the journey the business or brand needs to make. Then that journey is brought to life with inspiring, illustrative and memorable human stories to which people can relate.

Having created the Story, the leadership team is engaged and assisted in becoming effective and powerful communicators, equipped with creative storytelling tools to engage the organization through regular teams or sessions. These sessions are used to build a Story and action plan that is relevant to the team or region—a response to the master Story through the sharing of experiences, learnings, stories and ideas stimulated by meaningful discussions. Using special tools and techniques, the invention captures and shares the results of these discussions, campaigning them throughout the business to demonstrate progress, provide vital feedback, evaluation and learning to the leadership team. Using this feedback, executive(s) build the Living Story—a new version of the StoryMap to keep the drumbeat of the strategy and vision going, and to keep the story refreshed and alive. The Story can be developed and revised by more and more inspirational stories as they flow through the business, ready to re-engage the organization once more.

Initially, the strategy is turned into and/or developed into some narrative form, e.g., the story is created. Preferably this takes the form of a narrative framework enabling key messages to be linked into a narrative structure using clear and simple language. For example, a sequence of chapters may be written which illustrate why a metaphorical journey from where the business is at the moment to where the business wishes to be is an important one, what the business is trying to achieve by making that journey, and what priorities people need to focus on if the journey is to be successfully accomplished. By fleshing out such chapters with illustrative stories, which can be taken from real life and from the experience of the organization's employees and/or their customers, the narrative form may be cohered to a self-contained reflection of the strategy in question.

Once this has been done, the story is reflected or developed into a graphic representation, preferably in a map type form and preferably on a large scale, i.e., the size of the map or plan should be such as to enable a group of individuals to interact while all standing adjacent the map or plan, rather than each having to work with his or her own small scale copy of the map or plan.

By bringing together meetings of individuals, all of whom will be concerned with the strategy, they may be encouraged to explore their individual roles in the potential narrative in question, and this enables the narrative itself to be further developed. Eventually, and sometimes this requires more than one session to achieve, those core members of an organization in terms of implementing a particular strategy will have been able to refine and contextualize the narrative approach and to produce a story which is seen as relevant and engaging for those who will, downstream, need to implement the strategy.

Operating in this way promotes the co-ownership of the strategy by individuals operating at different levels within an organization and sometimes from different geographical locations, but within the same organization.

Once the refined form of the strategy has been developed in this way, the refined strategy can start to be deployed and can be achieved in accordance with the invention by the use of narrative form. By creating meaningful storytelling discussions within an organization, the people who need actually to implement the strategy are engaged with the strategy and begin to understand what they need to do in order to render the strategy successful. Such discussions can stimulate ideas and actions as well as enabling the sharing of best practice between colleagues and promoting a readiness to accept change.

During this phase of the business development, a large scale graphic representation of relevant portions of the overall narrative may be used. Preferably, these large scale graphic representations are interactive, for example can be written or drawn upon, enabling the individuals who are meeting and discussing actually to amend, develop and modify the graphic representation, for example by adding comments, target figures, or, indeed, anything which assists promoting the discussion and developing their part of the strategy.

Once the strategy starts to be rolled out, for example by way of an internal campaign, the strategy may be materially assisted by the final component of the business development method identified above, involving the individuals who are actually putting the strategy into effect into generating stories which can be fed back into the overall strategy with a view to developing the overall body of narrative material which relates to the strategy.

In this respect, a structured system is preferably used for encouraging the creation, recording and dissemination of narrative material which can be realized using modern communications structures, in particular a local area network installed for a given organization or group of organizations. By using an Intranet (or, of course, by simulating its equivalent using Internet connectivity), individuals may be encouraged to recount what occurs to them, including both what they have done in the business and what occurs to them derived from their experience, and communicate this information to a central collecting point where their contributions can be edited, correlated and formulated into substantial narratives which are, in turn, fed back to the individuals forming part of the organization.

An additional benefit of this approach is that by encouraging people to tell their stories, stories which are usually relevant and personal to the teller, but which are of value to their colleagues, an intimate picture can be built up of what is actually happening in a business and, more importantly, communicated to everyone else. By sharing stories, knowledge and experience, the individuals who make up an organization are better enabled to conceive, develop and execute action plans, to achieve specific business targets, and to improve the overall performance of the business. By operating in this way, it is possible not only to improve the profitability of a business, but beneficially to modify the overall culture of the business concerned, at the same time as exerting appropriately benevolent pressures on individuals in the business to improve attitude and motivation, and improving employee retention.

In practicing the method of the present invention, the method further includes developing a strategy including generating, developing and sharing narrative content among a user group which, by identifying individuals to constitute a user group, provides those individuals with a manner to input narrative content into a common storage unit; monitoring, and optionally editing, content placed by the individuals on the storage unit; analyzing content so placed to identify relationships to earlier placed content; applying associations to the content on the common storage unit between individual items of content, and enabling those who are part of the user group to view those content items placed on the common storage unit by others.

### BRIEF DESCRIPTION OF THE DRAWINGS

Referring to the drawings:

FIG. 1 illustrates a flow chart of an embodiment of stages of the present invention.

FIG. 2 illustrates an embodiment of Stage 1 of FIG. 1 of the present invention.

FIG. 3 illustrates an embodiment of Stage 2 of FIG. 1 of the present invention.

FIG. 4 illustrates an embodiment of Stage 3 of FIG. 1 of the present invention.

FIG. 5 illustrates an embodiment of Stage 4 of FIG. 1 of the present invention.

FIG. 6 illustrates an embodiment of Stage 5 of FIG. 1 of the present invention.

FIG. 7 illustrates an embodiment of Stages 6/7 of FIG. 1 of the present invention.

FIG. 8 illustrates an embodiment of creating the senior leader's story with core SLT of FIG. 2 of the present invention.

### DETAILED DESCRIPTION OF THE PREFERRED EMBODIMENTS

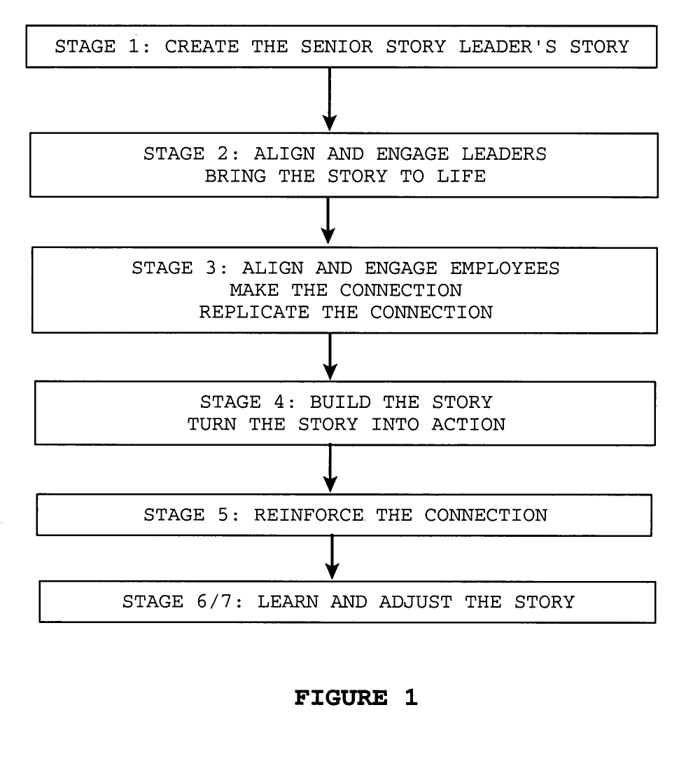

Referring to FIGS. 1-8, the method and system of the invention is more particularly detailed hereafter. In putting the method and system of the invention into effect, there are accordingly a number of phases following the initial formulation of a strategy, e.g. by senior management. These phases include initial engagement, building the story and creating the living story. Each phase a set of predetermined tools and storytelling techniques.

The initial engagement phase preferably includes: create the journey, engage the leadership and engage the organization.

Create the Journey

The StoryMap is a key navigational tool that enables simplification of the strategy or vision, focussing on key messages, cutting out jargon and complexity, and linking them in a series of ‘chapters’ that represent why the journey is important, what the business is trying to achieve and the priorities on which people really need to focus. Each chapter is then brought to life through a series of illustrative stories—real-life human experiences about employees or customers that give the chapter meaning and help connect the audience to the journey, both rationally and emotionally. Once signed off by the key stakeholders, the StoryMap is given a powerful visual identity which creates impact, reflects the essence of the brand and the storytelling campaign as a whole.

Engage the Leadership

The leadership must become architects, not just messengers, of the Story, thereby fully committing to the Story themselves before engaging their teams in the Story. So when the Story is presented for the first time, the focus is on co-creation. The leadership explores both their and their teams' role in the journey and what needs to be done to move the journey forward, offering individual stories to help contextualize the StoryMap.

The Story will then become relevant and personal to the function or region as a response starts to build. Sometimes, different, localized versions of the Story can be created as a result of this ‘interrogation’, and will not allow the Story to go out to the teams until the leadership understands and have fully developed the story.

Engage the Organization

Using the principles of storytelling combined with proven methodologies such as appreciative inquiry, unique engagement sessions are developed during which the leaders can engage the teams in the Story and start to interpret what the Story means to them and how the team can be involved. Leaders are equipped with a whole range of creative resources, from simple print to high impact multi-media, to help keep the Story captivating and consistent, with extra coaching (on-line or in person) available if required.

The building the story phase preferably includes: meaningful discussions and capture and share.

Meaningful Discussions

As people start to build their own Story, discussion and exploration what the Story means to them occurs, and the implications for their teams. These discussions, often stimulated and fed by stories, engage people in the journey the business is making and what can be done differently to make the business a success. Supported by special creative tools, the discussions fuel ideas and actions, help share best practice and encourage people to embrace change. Provoked by the content of the StoryMap, the discussions also inspire people to tell their own stories of success and achievement, which in turn will lead to further discussions.

Capture and Share

Capturing and sharing the results of these discussions improves knowledge management and encourages continuous learning, and celebrates success and achievement, recognizing local heroes and changing and embedding behaviors. The sharing of stories and ideas generates a great collective energy that has a positive effect on performance, allowing people to be heard and their input valued. StoryWeb, special web-based application, enables people to capture and share stories effortlessly and facilitates this process, and is supported by existing channels of communication and special campaigning materials such as postcards, posters, booklets, podcasts and awards.

The creating the living story phase preferably includes: evaluate and learn and the living story.

Evaluate and Learn

With a collective Story to tell, the organization needs to sustain engagement in the journey—the Living Story. Creating the Living Story celebrates the achievements of the journey so far, evaluating and learning from what has happened since the journey was launched, re-focuses people on the current strategic challenges and re-engages them in their role.

The Living Story

The Living Story is shaped at a summit meeting involving the leadership and a cross-section of people from their teams. The meeting is used to evaluate the success of the Storybuilding—what has worked well, what has changed, where success has shone through and what can be done to build on this success. The findings, learnings, stories and experiences will start to shape the next stage of the journey ‘in the moment’. Key themes are captured, new priorities are identified and a new StoryMap will start to emerge, ready to re-engage the organization once more.

In a preferred embodiment, the means to input narrative content is structured using a computer screen-based web form approach. In this way, a common structure for content, or possibly several common structures for different types of content, may be developed which materially assists analysis and editing.

In particular, the invention assists those in the business charged with operating the method to edit narrative content from different users in the user group to construct a coherent enlarged narrative, which enlarged narrative may then be made available to all members of the user group.

In practical terms, this aspect of the present invention is put into effect by enabling use on a multi-user computer system which is accessible to the individual users and which enables the individual users to post or download content respectively for processing by others or viewing by the user. The system may use conventional approaches to maintaining availability, and to enable control of the user group, e.g., by providing log-in and password protected access to the content material which builds up in the system.

In one embodiment, the system and method may be operated by way of a dedicated server connected to an organization's Intranet. In another embodiment, the system and method may be operated using a dedicated server or as part of a bigger high capacity server which is simply connected to the Internet and which can be accessed using an appropriate URL. The server may carry, as part of the system, conventional tools such as local search engines to enable particular content to be found and, if the user has appropriate privileges, manipulate the content or subject content items to different relationship allocations.

An embodiment of the method and system of the invention, as shown for example in FIG. 1, preferably includes various stages including, but not limited to, the following: Stage 1—create the senior story leader's story; Stage 2—align and engage leaders, bring the story to life; Stage 3—align and engage employees, make the connection, replicate the connection; Stage 4—build the story, turn the story into action; Stage 5—reinforce the connection; Stages 6/7—learn and adjust the story.

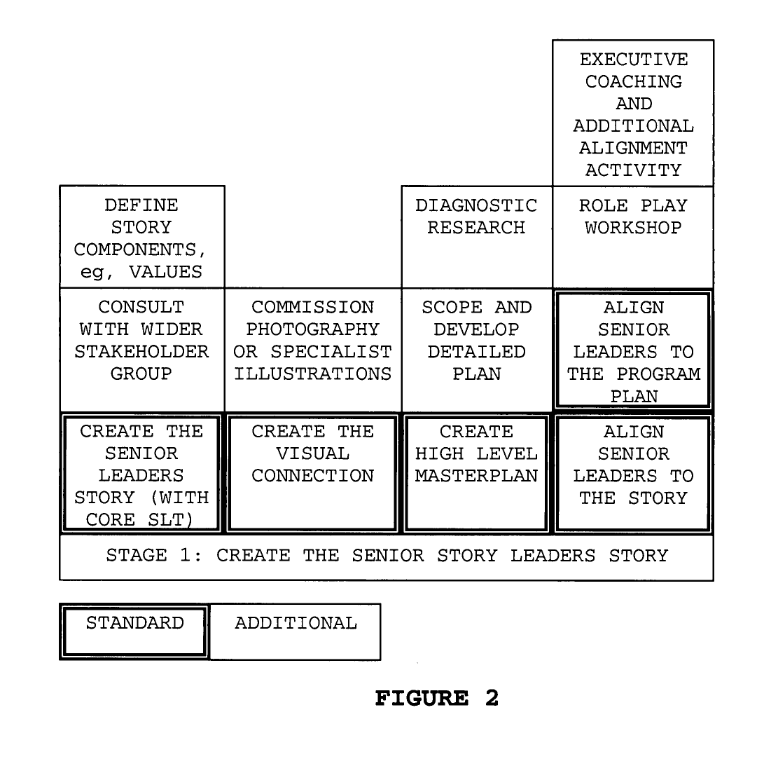

Each stage may include various steps that can be performed during that stage. In a preferred embodiment, such as shown for example in FIG. 2, Stage 1—create the senior story leader's story—preferably includes: create the senior story leaders story (with core SLT) (SLT is Senior Leadership Team), create the visual connection, create high level masterplan, align senior leaders to the story and align senior leaders to the program plan. Stage 1—create the senior story leader's story—may also include: define the story components, e.g., values, consult with wider stakeholder group, commission photography or specialist illustrations, diagnostic research, scope and develop detailed plan, executive coaching and additional alignment activity, role play workshop, and/or any other suitable step.

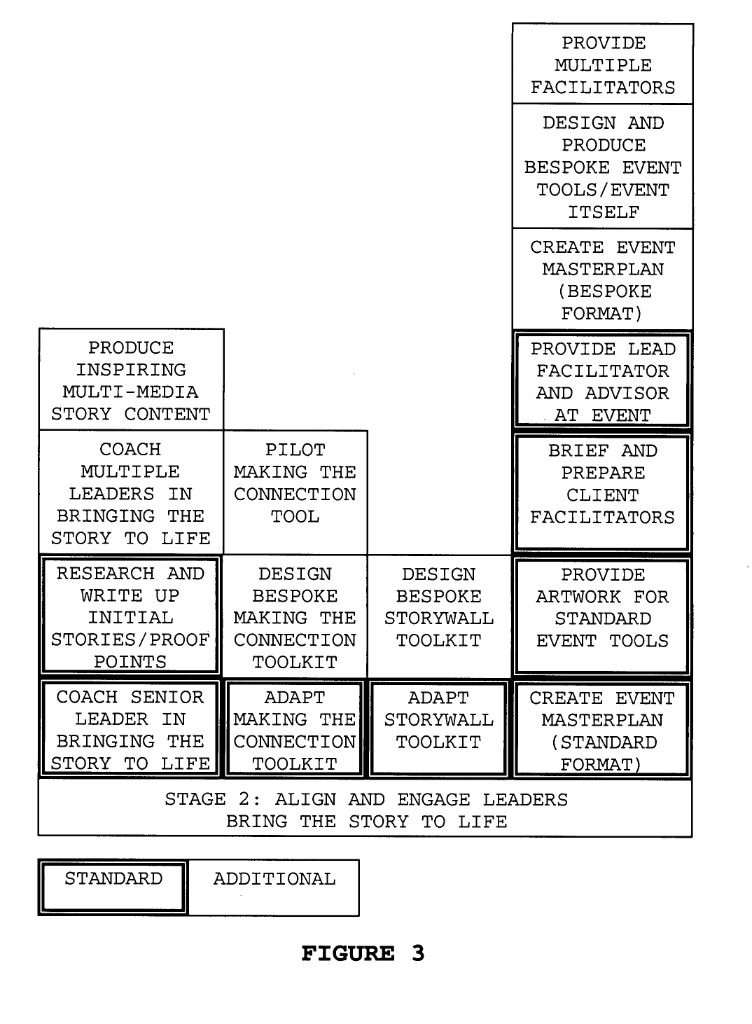

In a preferred embodiment, such as shown for example in FIG. 3, Stage 2—align and engage leaders, bring the story to life—preferably includes: research and write up initial stories/proof points, coach senior leader in bringing the story to life, adapt making the connection toolkit, adapt storywall toolkit, provide lead facilitator and advisor at event, brief and prepare client facilitators, provide artwork for standard event tools, and create masterplan (standard format). Stage 2—align and engage leaders, bring the story to life—may also include: produce inspiring multi-media story content, coach multiple leaders in bringing the story to life, pilot making the connection tool, design bespoke making the connection toolkit, design bespoke storywall toolkit, provide multiple facilitators, design and produce bespoke event tools/event itself, create event masterplan (bespoke format), and/or any other suitable step.

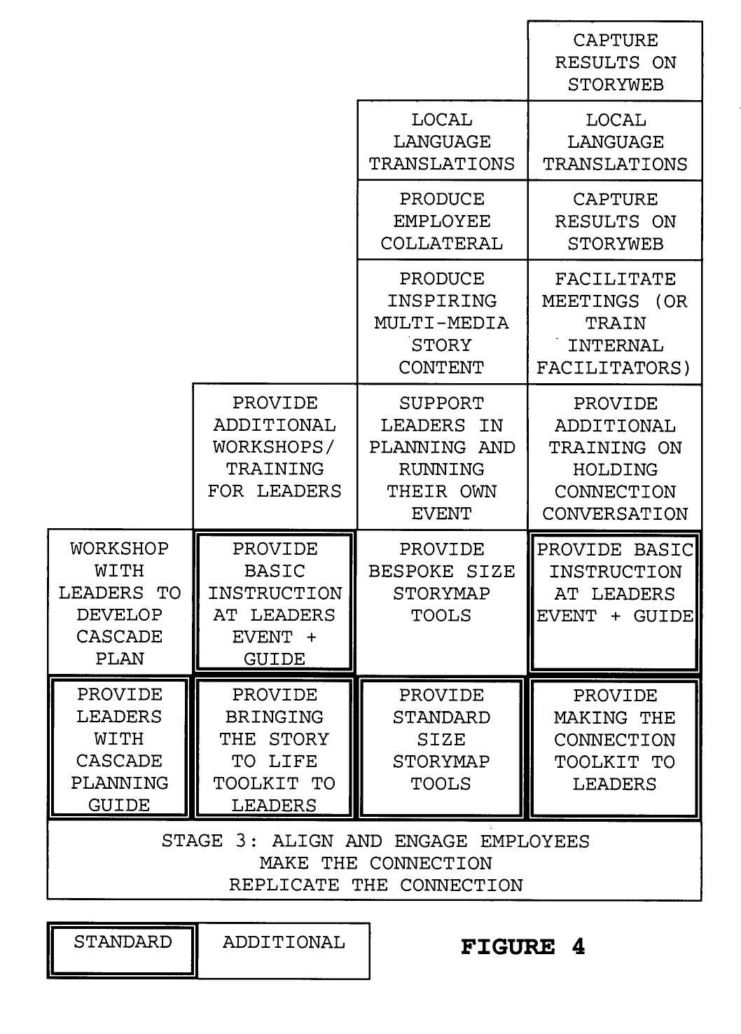

In a preferred embodiment, such as shown for example in FIG. 4, Stage 3—align and engage employees, make the connection, replicate the connection—preferably includes: provide leaders with cascade planning guide, provide basic instruction at leaders event plus guide, provide bringing the story to life toolkit to leaders, provide standard size storymap tools, provide basic instruction at leaders event plus guide, and provide making the connection toolkit to leaders. Stage 3—align and engage employees, make the connection, replicate the connection—may also include: workshop with leaders to develop cascade plan, provide additional workshops/training for leaders, local language translations, produce employee collateral, produce inspiring multi-media story content, support leaders in planning and running their own event, provide bespoke size storymap tools, capture results on storyweb, facilitate meetings or train internal facilitators, provide additional training on holding connection conversation, and/or any other suitable step.

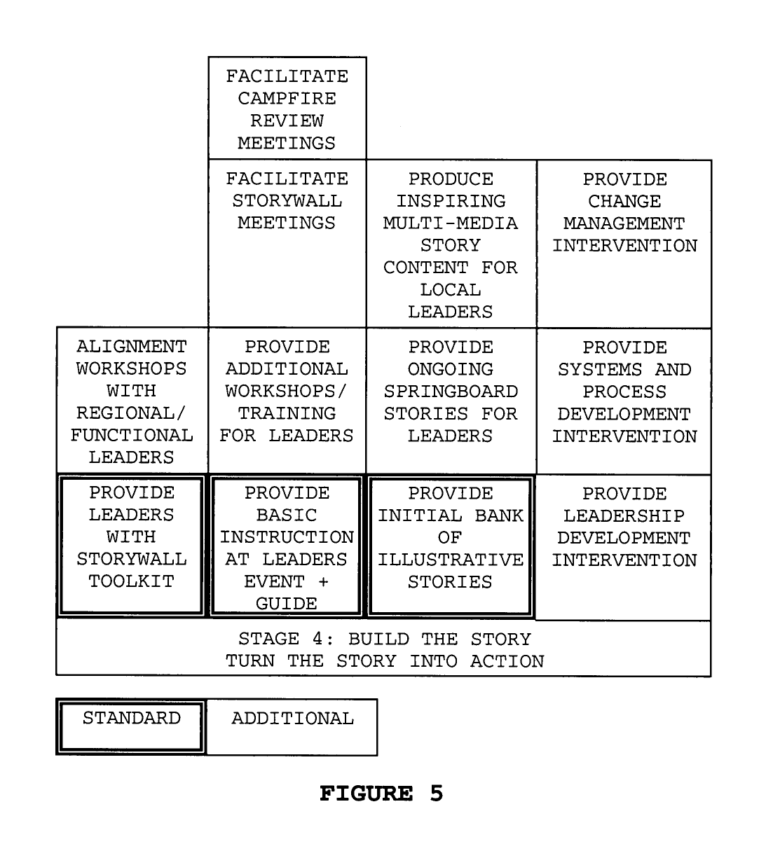

In a preferred embodiment, such as shown for example in FIG. 5, Stage 4—build the story, turn the story into action—preferably includes: provide leaders with storywall toolkit, provide basic instruction at leaders event plus guide, and provide initial bank of illustrative stories. Stage 4—build the story, turn the story into action—may also include: alignment workshops with regional/functional leaders, facilitate campfire review meetings, provide additional workshops/training for leaders, produce inspiring multi-media story content for local leaders, provide ongoing springboard stories for leaders, provide change management intervention, provided systems and process development intervention, provide leadership development intervention, and/or any other suitable step.

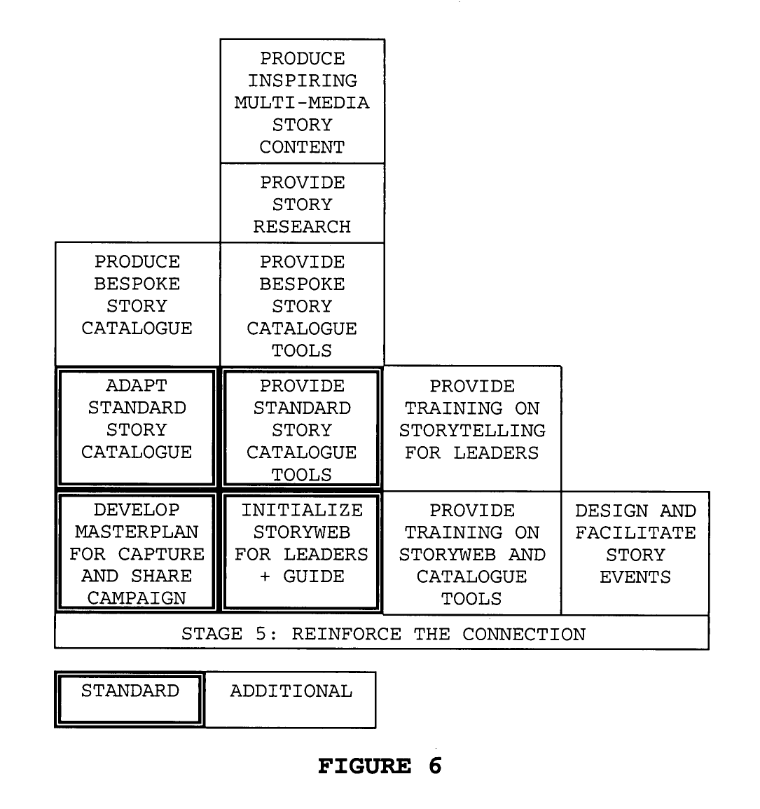

In a preferred embodiment, such as shown for example in FIG. 6, Stage 5—reinforce the connection—preferably includes: adapt standard story catalogue, develop masterplan for capture and share campaign, provide standard story catalogue tools, and initialize storyweb for leaders plus guide. Stage 5—reinforce the connection—may also include: produce bespoke story catalogue, produce inspiring multi-media story content, provide story research, provide bespoke story catalogue tools, provide training on storytelling for leaders, provide training on storyweb and catalogue tools, design and facilitate story events, and/or any other suitable steps.

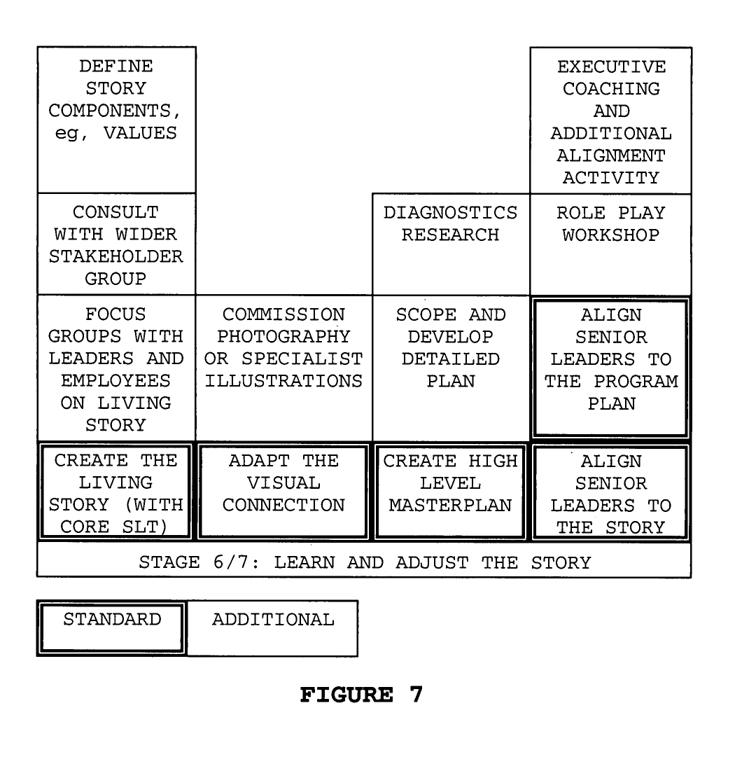

In a preferred embodiment, such as shown for example in FIG. 7, Stages 6/7—learn and adjust the story—preferably includes: create the living story (with core SLT), adapt the visual connection, create high level masterplan, align senior leaders to the program plan, and align senior leaders to the story. Stages 6/7—learn and adjust the story—may also include: define story components, e.g., values, consult with wider stakeholder group, focus groups with leaders and employees on living story, commission photography or specialist illustrations, diagnostics research, scope and develop detailed plan, executive coaching and additional alignment activity, role play workshop, and/or any other suitable step.

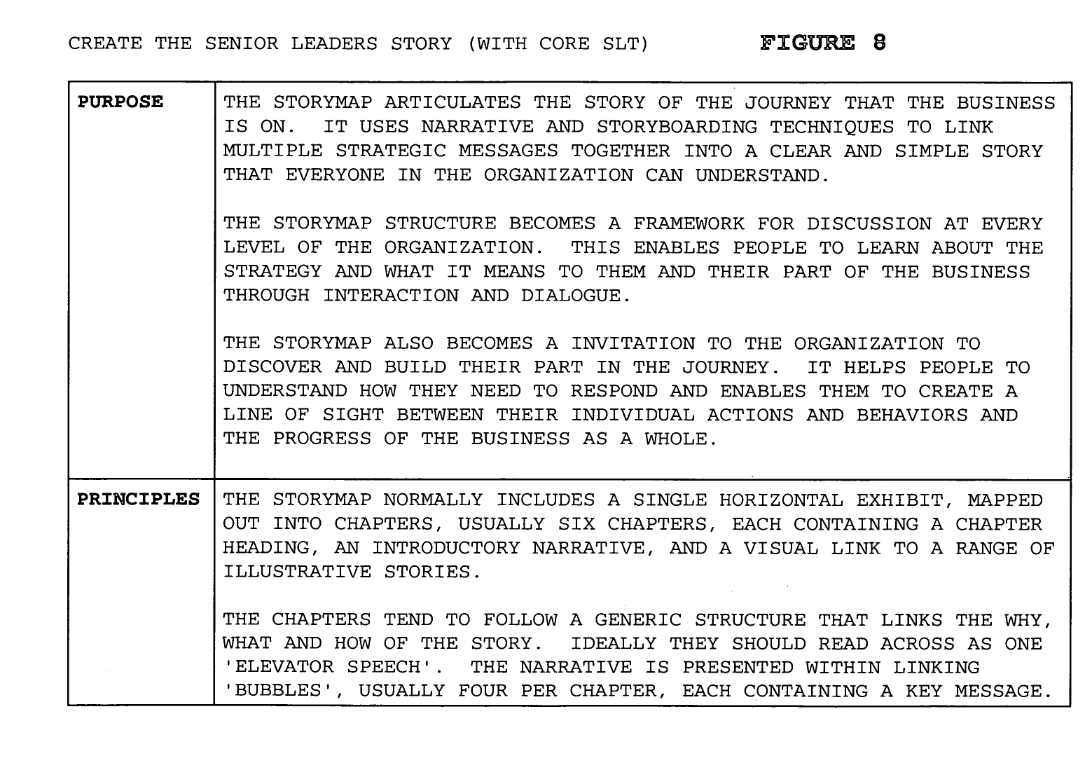

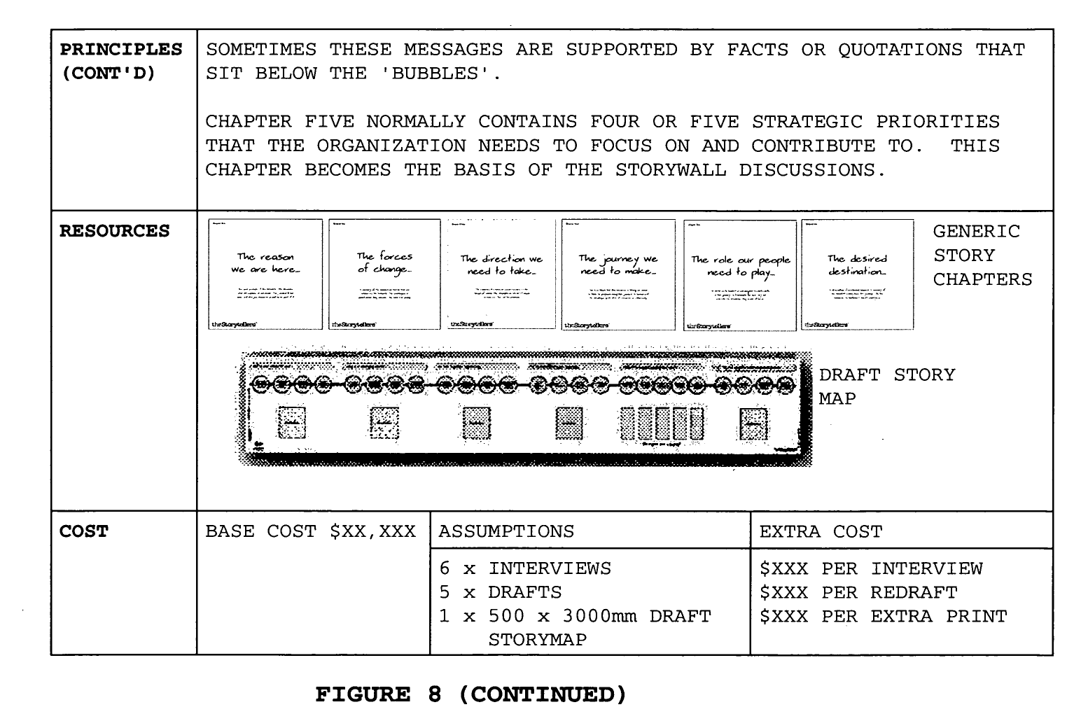

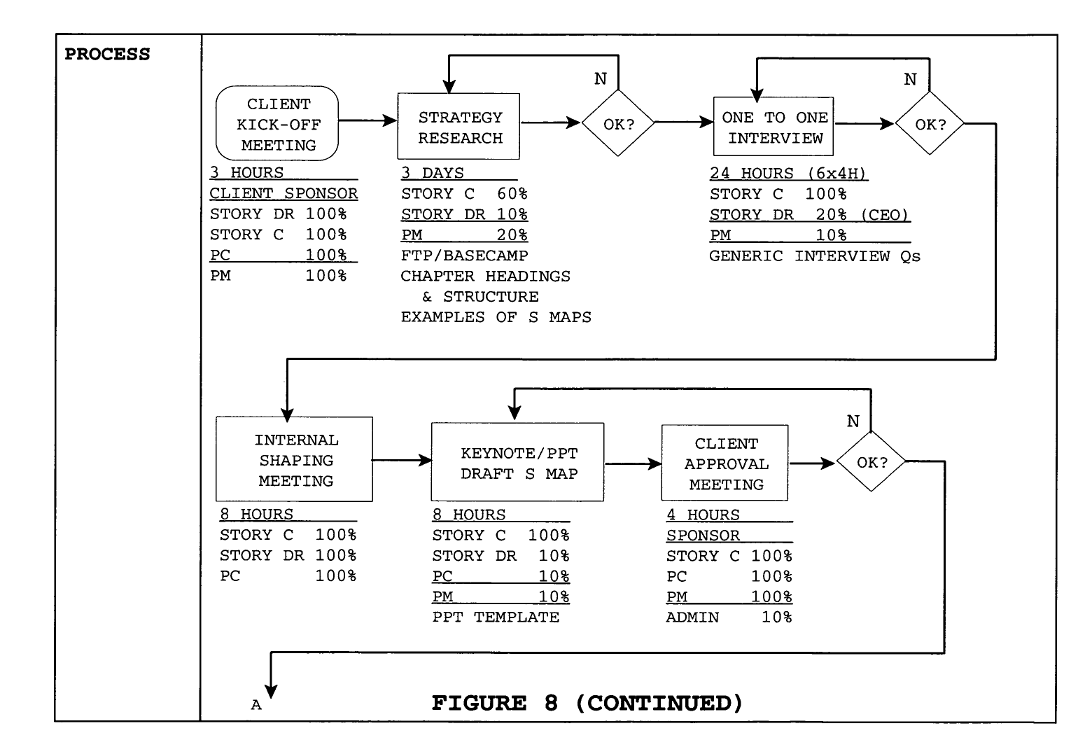

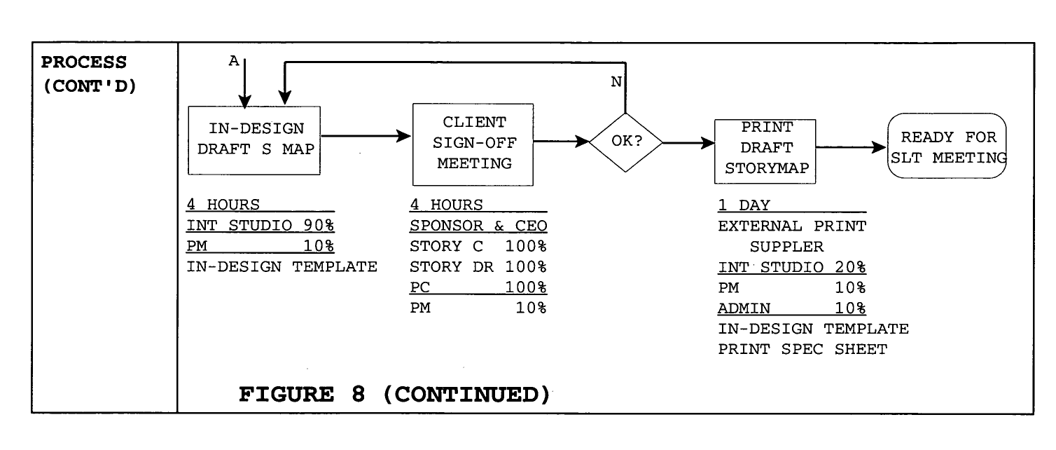

Each of the steps detailed above may be further developed such as shown for example in FIG. 8. FIG. 8 illustrates Stage 1—create the senior leader's story (with core SLT)—in more detail, providing the purpose, principles, resources, process and cost which may be associated with that step of the present invention. Any other suitable material may be listed in the further details of any of the steps of the invention.

There are a wide variety of ways of putting the various aspects of the present invention into practice. The following example is one way of how the method and system of the present invention may be put into effect.

### Example

A “Storyweb” system was set up to enable the effective capturing and sharing of internal stories from employees throughout an organization operating a campaign, for example, a launch of a new service to customers. The objective of the Storyweb system was to provide an effective tool for the organization to capture inspiring real stories from real people within the organization and have them shared. By sharing stories submitted, the individual people in the organization were able to understand much better where they were all going, and were able to feel a part of the organization to an extent not previously achieved.

The basic hardware requirement for operating the system was a dedicated web server appropriately optimized to host the system to operate the program. The server was linked to the corporation's Intranet and provided with the ability to communicate with individual users via a secure socket layer protocol including appropriate level encryption. The detail of the applications which were designed to operate as set out below was developed using Ruby on Rails, enabling rapid and maintainable application development. However, any suitable application may be used to develop the details of the system applications. A MYSQL database server was chosen on the grounds of rapid performance, high reliability and ease of use. An additional bonus arising from this choice of development tool and platform was that both technologies are open source.

The user interface of the application on the server was constructed using XHTML and Cascading Style Sheet (CSS) as this enabled content to be separated from presentation, so ensuring that the application was accessible by a wide range of browsers and Internet devices throughout the organization. However, any suitable method may be used to construct the user interface. The application could easily be maintained since the styles presented to users of the system were controlled by one or two style sheet files. As appropriate or necessary, functionality to effect the operations noted below could be provided using Java script and XML (also known as AJAX). However, any other suitable means may be used.

The general requirements set by the organization were that the design of the system should be attractive and engaging to encourage employees to submit and share stories. As the content could be commercially sensitive, the system needed to offer a reasonable amount of security to prevent unauthorized access. The system also needed to meet sensible accessibility guidelines to enable the system and method to be available without discriminating against disabled or partially disabled employees, and particularly not one which is discriminated on the basis of visual ability. The system needed to be easy to use by employees at any level and the system should be available 24 hours a day, 7 days a week. Additionally, download and upload times should be rapid.

The functional specification of the Storyweb system adopted was as follows:

Access

Access to the Storyweb system is via a public URL which will require a login. Each client organization has a separate sub-domain (canonical) from the main Storyweb domain, e.g. [clientname].storyweb.com. The client's Storyweb URL could be available as a hyperlink from an intranet (providing external Internet access is available), or accessed directly via the URL in a web browser.

Login

At the login screen, in addition to the input boxes for the username and password, a “lost password?” option may exist where the user can enter the username and retrieve the password. If the user cannot remember their username—the user is able to view the details of the client's administrator so the user can contact the administrator for the username/password.

The username could be the person's email address—this would allow user names to be unique and easy to remember.

User Levels

There are preferably three levels of access to the Storyweb system, as follows:

1. Client User

The client user is the most common type of user and is typically an employee of the client organization. The client user has access to the main functionality of the system, i.e, submitting and viewing/sharing stories.

2. Client Administrator

The client administrator is preferably a communicator appointed by the client organization to manage the campaign on the Storyweb system. The client administrator would have access to all of the functions of the client user plus specific functionality to manage the campaign.

3. System Administrator

The system administrator is preferably the person(s) within the hosting organization responsible for creating and managing client accounts and campaigns on the Storyweb system. The system administrator is preferably the highest level of access and has access to all levels of functionality, including the ability to create/manage stories on any campaign.

Creating and Editing Stories

The system provides for creating and editing stories. At the creation level, each story includes the material entered into fields including, but not limited to: the name of the story; a creative title for the story; an image or illustration; a related chapter or focus; Level 1 story responses (see below); and/or the text for the story.

There are several levels of the story with different attributes to distinguish them. The stories are not necessarily referred to be their level within the application, but may be presented in lists in a different way to highlight different levels.

Most stories preferably evolve from Level 1 stories through to Level 3 stories.

Level 1 Stories

Level 1 stories are likely the most common type of stories in the campaign. To create a Level 1 story, the user simply has to answer a predetermined number of questions and the answers to these questions are concatenated, i.e., linked together in a series, with pre-defined sentences to achieve a very basic story. The question responses form the content of the story.

The user is also optionally able to upload an image for the story if they wish.

Level 1 stories are preferably Local stories with the region defined as the region of the user who created the story.

Preferably, client users may only be able to add Level 1 stories.

Level 2 Stories

Client administrators and system administrators are able to develop Level 1 stories by editing any of the fields (including making a Global story) and adding copy to the main story text field of the story. This written copy then becomes the main story text, taking precedence over the Level 1 question responses.

Once a story has an image uploaded and the story text field has been populated, the story becomes a Level 2 story.

Level 3 Stories

Level 3 stories are preferably Level 2 stories, which may have received further refinement and have related files/resources associated with them. These files preferably include, but are not limited to, the following types: PDF document; PowerPoint presentation; MPEG video file; MP3 audio file; and/or any other suitable file. These file types could be added to in the future and would likely be linked to the resource ordering facilities described below under “Future developments”.

Each uploaded file preferably has the following information, including, but not limited to: title; brief description; file type (as detailed above); filename and path/location; and/or any other suitable information.

Only client administrators and system administrators are able to create/develop Level 3 stories.

Client User Functionality

Campaign Overview

When a client user has successfully logged into the system, the client user is presented with the campaign overview page. This page can be considered a “homepage” of sorts in the sense that this page acts as an introduction and overview to the campaign.

The campaign overview preferably includes, but is not limited to, the following content: brief text introduction to campaign/Storyweb system; Storymap navigation device (see below); campaign navigation; links to latest stories; and/or any other suitable material.

Storymap Navigation

The Storymap navigation device is displayed on all main pages of the Storyweb campaign pages and displays a list of the chapters within the “story” (campaign) in a horizontal layout, representing the timeline of the overall story. Each chapter also contains the relevant bubbles (main points) within that chapter.

When the user hovers their mouse pointer over a chapter bubble icon, a browser “tooltip” preferably displays the text for that particular bubble. By clicking a chapter from the navigation device, the user is taken to the relevant chapter view page (see below).

Chapter View

By clicking a chapter from the Storymap navigation, the user is presented with the chapter view page.

The chapter view displays the following content including, but not limited to: the chapter title; the chapter description; the chapter bubbles; an image or illustration for the chapter; links to stories relating to the particular chapter; option to subscribe to a RSS feed (Really Simple Syndication, RDF Site Summary or Rich Site Summary) for stories from this chapter; option to receive email alerts; and/or any other suitable material.

Story View

When a user clicks a story headline, they are presented with the full details of the story, with content preferably including, but not limited to, the following:

Main Story Text

The main story text may include, but is not limited to, an image or illustration that has been uploaded for the story; the title of the chapter or focus that the story is related to with a link to the chapter view; a selection of links to related stories; links to story actions and options (see below); links to file downloads (for Level 3 stories); and/or any other suitable content.

Story Actions/Options

Actions are the options relating to a particular story, which are available from the story view.

Email to a Friend/Colleague

The user can choose this option, enter a name email and an optional message and send an html email of the story to a friend or colleague.

The email would contain a link back to the story view on the storyweb system. This is designed to increase interaction with the storyweb system and drive participation amongst employees. However, the system may be configured to restrict emailing stories to email addresses on a particular domain to ensure that potentially sensitive strategic business information is not distributed outside the organization.

An alternative option should be provided to enable the user to select another user registered on the storyweb system to email a story to, and use the email they have registered as their login to send these emails to them.

Print the Story

By selecting this option, the user is presented with a print-friendly view of the story so they can simply print out and share the story. The print-friendly view is created using a CSS style sheet and is different to the StoryCard PDF option described below in that the CSS style would be a faster way to print the story out and would contain more elements from the application. The print option would also not require the Adobe Acrobat reader.

Set Email Alerts

By choosing this option, the user will be presented with options enabling them to receive email alerts when stories matching certain criteria are added to the system.

Initially, the following options for receiving email alerts are preferably available, but are not limited to: stories added to a particular chapter; stories added by a particular user; stories added from a particular region; stories added with particular keywords in text; and/or any other suitable option.

Download StoryCard (PDF)

Choosing this option would generate a PDF file for this Story, also known as a StoryCard. When a campaign is setup by the system administrator, a template for these PDFs is added. The functionality for generating and downloading the PDF files would be similar to the work already completed on the “StoryCard factory” application created for EDS (Electronic Document System or Electronic Data System).

RSS Feeds

The system will offer a number of options for the user to subscribe to RSS feeds from the story web application. The user could then receive a live feed of new stories from the campaign straight to their desktop.

The following variations would be available:

Full RSS Story Feed

The full RSS story feed, preferably features the name, title and a link to the story view for all stories when the stories are added to the system.

The RSS feed would not contain the entire story content, but rather encourages the subscriber to click the link in the feed and view the story on the Storyweb system.

Chapter(s) RSS Feed

This feed would list stories from one or more chapters as the stories are added to the system.

Custom RSS Feeds

The user would also be able to “build” their own feed using a simple tool consisting of several drop down options, including, but not limited to: stories from a particular user; stories containing particular keywords; stories from a particular region; and/or any other suitable drop down option.

Story Search

The user will be able to search for stories using several types of information as search parameters, including, but not limited to: stories containing certain keywords; stories by a particular person (user); stories from a particular region; and/or any other suitable search parameter.

The results from the search would be displayed in a paginated list.

MY Stories View

The user can select an option from the campaign navigation to enable them to view a list of the stories they have created and add new stories and edit existing ones.

Adding Stories

Client users of the application will be able to add Level 1 Stories to the campaign, as detailed above.

Client Administrator Functionality

The client administrators will have access to all the functionality available to the main client users, with the addition of several other important features.

Dashboard

When logging on to the StoryWeb system, the client administrators will be presented with the dashboard view. This dashboard view gives an overview of the campaign to date and provides a live snapshot of several important statistics to allow the monitoring of campaign activity.

The dashboard displays statistics such as, but not limited to, the following: number of current users logged in; number of stories created by region; number of stories created by chapter; number of downloads by region; most popular stories; total number of stories created to date; total number of PDF downloads to date; and/or any other suitable statistics. Where appropriate, this information can be displayed in dynamically generated chart graphic, such as pie charts.

User Management

The client administrators are preferably responsible for managing user accounts for the campaign. This would include creating, editing and deleting users from the system.

Each user account preferably contains, but is not limited to, the following information: username, e.g., email address; password; first name; last name; telephone number; region; user level, i.e., client user or client administrator; activation date; and/or any other suitable information.

When adding users, the administrator is able to add one user at a time or create several at the same time using a form with several rows.

There would also be the option to generate a random password for the user, which the user could later change themselves.

Once a user has been added to the system, an automatic welcome email is generated and sent to their email address. The welcome email would contain a hyperlink which, when clicked, would activate the account and then display their password on screen as well as offering them the option to change the password to something more memorable.

The user would be asked to supply a telephone number as an additional method of contact, should an administrator/communicator need to contact them to find out more about a story to enable the story to be developed (ritualized).

Manage Stories

The client administrators are preferably able to add their own stories to the campaign and edit any stories created by client users, including, but not limited to: changing a story's region from Local to Global; editing the story text or question responses; replacing images; changing the related chapter/focus; adding files to the story, e.g., making the story a Level 3 story; and/or any other suitable material.

Storytellers Administrator Functionality

Dashboard

The Storytellers dashboard would operate in a similar way to the dashboard displayed to the client administrators, except the Storytellers dashboard would display information from across all active campaigns. The Storytellers administrator are preferably able to specify via a drop down menu whether to view data from all campaigns or select one in particular to view. The following information is preferably available, but not limited to: number of current users currently logged in; number of stories created by region; number of stories created by chapter; number of downloads by region; most popular stories; total number of stories created to date; total number of PDF downloads to date; and/or any other suitable information.

The system administrator dashboard also includes a facility to export data of certain statistics in CSV (Comma Separated Values) format, which can be used in Excel to generate reports and charts. This information may be used by the system administrator to provide written reports to clients on an agreed schedule.

Manage Clients

The administrator will be able to add and edit clients to the system.

The following information may be stored: client name; client contact name(s), telephone, mobile and email; client logo; and/or any other suitable information.

Manage Campaigns

A client may undertake more than one campaign with the same system administrator. These campaigns may or may not be run concurrently. Some time after delivering one campaign for a particular set of strategic objectives. A new campaign with a new set of objectives.

The system administrator must thus be able to create new campaigns and edit settings for existing campaigns.

Each campaign preferably includes, but is not limited to, the following:

Campaign Title

Each campaign may be given a title. However, a title may not be required or used, i.e., there will only be one campaign for a client.

Campaign Introduction

A campaign introduction is a brief text paragraph which would act as an overview for the campaign.

Client

Each campaign is allocated to a particular client. The administrator would either select an existing client from the list or choose an option to add a new client.

StoryMap Content

Each campaign is focused around a StoryMap having several chapters (one of which is the “focus” chapter). Each chapter includes, but is not limited to: chapter title; image or illustration; several bullet points or “bubbles” (typically 3 to 5), which consist of a text description; and/or any other suitable material. In the case of the focus chapter, each bubble also has an image/illustration.

The administrator is able to add and edit chapters and bubbles, re-order chapters and choose one chapter to be the focus chapter.

Level 1 Story Content

The questions used in the “add story” functionality for main client users to create Level 1 stories and the corresponding sentences used when viewing the stories is able to be specified per campaign.

CSS Styles

Each campaign will have a Cascading Style Sheet (CSS) file associated with the campaign, which will determine the styling of the StoryWeb interface in terms of brand colors, border styles, font style and size and other style features. This will enable each client to achieve a level of customized look and feel, while retaining the structure and underlying layout of the StoryWeb application.

Master CSS files control common elements and styles throughout the StoryWeb application and these would be edited and managed separately, outside the application. Changing code within the master stylesheets would affect the appearance of the application in all campaigns, so changes and modifications to these would need to be tested thoroughly before being rolled out.

If no campaign stylesheet is added, then the application will use a default stylesheet, which would be fairly neutral with regards to colors.

Templates

Several templates will need to be created for the campaign, including, but not limited to: header file (client logo, etc.); StoryCard PDF template; email-to-friend template; welcome email template; print stylesheet; and/or any other suitable template.

System Messages

The system administrator can create system-wide bulletin messages. Typically, these messages could be used to alert users to planned system maintenance or downtime. System messages include, but are not limited to the following fields: title; main text (styled using simple text formatting for hyperlinks and bold, etc.); start date; end date; option to specify who should see the message (i.e., all users, only client users or only client administrators). The start and end dates could be used to post a message to appear at a future time and last for the specified duration.

Resources

Manage Functionality/Options

The system administrator enables and disables certain features and functionality per campaign. This could be for several reasons including, but not limited to: certain features may not be required by certain clients or for certain campaigns; the system administrator may wish to offer some of the functionality at additional cost to the client and therefore have certain features not included as standard; and/or to enable the client to begin creating and sharing stories immediately without waiting for templates and styles to be created for their campaign.

The following features and functionality may be enabled/disabled: RSS feeds; email alerts; generating StoryCard PDFs; and campaign styles (would default to standard neutral colors).

Manage Resources

Each campaign could also feature a list of downloadable support materials. These materials may be managed by the system administrator and would initially consist of PDF files, JPEG images, Word documents and PowerPoint files and any other suitable files. The system administrator can add, edit and delete these resources from the campaign. Each resource includes, but is not limited to, the following data: resource title; brief description; file type (Image, Word document, PowerPoint, etc.); filename and path/location; and/or any other suitable data.

Future Developments

The system design allows for various ways in which the application could be developed and refined over time, in response to feedback from clients and experience gained from campaigns undertaken.

The system may also include the following functionality:

Print Resource Ordering

Print resource ordering includes ordering print resources from a print management company.

The system and method of the invention may also include ordering of print resources using a print credits system, where each resource would be allocated a value in credits and the system administrator would manage the pre-purchase of print credits for each client to enable them to order resources themselves as and when required.

Keyword Tagging

To aid navigation, the system and method may include classification and browsing of stories, i.e., tagging functionality. When editing or creating a story, a text field may be added which enables the user to add keywords (tags) which are considered relevant for the story, separated by spaces.

The tags entered for the story can be included on the story view, and the user is able to click the keyword and view a list of other stories which share that tag.

The campaign overview page may feature a “tag cloud”, where most popular keywords are listed and displayed according to their popularity. This functionality would work in a similar way to other web applications such as, for example, Flickr and del.icio.us, to provide a useful and interesting way to navigate and find stories.

Custom Reporting

As campaigns are executed, a clearer understanding will evolve of the data required to monitor effectiveness of campaigns on an ongoing basis. The system and method accordingly provides functionality to add further reports and statistics to the dashboard views and/or provide a facility for running ad hoc reports.

Campaign html Templates

Initially, the layout of each page within the application will have the same layout across all campaigns, and the styles (colors, text style, etc.) will be customized via a campaign stylesheet.

Further, the system and method may define a set of layout templates per campaign also, allowing a higher level of customization and control over look and feel for each individual campaign.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

It is claimed:

1. A method of business development comprising:
formulating a forward strategy by one or more individuals;
formulating the strategy into a narrative story;
providing a graphic representation of the narrative story;
developing the narrative story for the strategy;
tailoring the narrative story to particular persons or groups of persons with predetermined responsibilities;
disseminating the narrative story or sub-portions of the narrative story to relevant persons or groups of persons within an organization;
promoting narrative feedback from the relevant persons or groups of persons; and
implementing the forward strategy by way of the narrative story.

2. The method of claim 1, wherein the formulating the strategy into the narrative story includes an initial engagement phase, a building a story phase and a creating a living story phase.

3. The method of claim 2, wherein the initial engagement phase includes at least one of: creating a journey, engaging a leadership of an organization, and/or engaging the organization.

4. The method of claim 2, wherein the building the story phase includes at least one of: discussions, and/or capturing and sharing results of discussions to improve knowledge of management and encourage continuous learning, success and/or achievement.

5. The method of claim 2, wherein the creating the living story phase includes at least one of: evaluating and learning from what has happened since a journey was launched, and/or refocusing and re-engaging users in a role and a living story.

6. The method of claim 1, wherein the formulating the strategy into the narrative story includes at least one of: enabling key messages to be linked into a narrative structure using clear and simple language; and/or writing a sequence of chapters which illustrate why a metaphorical journey from where a business is at one moment to where the business desires to be, what the business is trying to achieve by making the journey, and what priorities users need to focus on if the journey is to be successfully accomplished.

7. The method of claim 1, wherein the providing the graphic representation of the narrative story includes creating a large scale map to enable a group of users to interact with each other and in conjunction with the map.

8. A method of business development comprising:
creating a story by a senior story leader user;
aligning and engaging leader users and bringing the story to life;
aligning and engaging additional users, making a connection, and replicating the connection;
building the story and turning the story into action;
reinforcing the connection; and
learning and adjusting the story.

9. The method of claim 8, wherein the creating the story by the senior story leader user includes at least one of: creating the story by the senior story leader user with Senior Leadership Team; creating a visual connection; creating a high level masterplan; aligning senior leader users to the story and aligning senior leader users to a program plan; defining components of the story; consulting with a wider stakeholder group; commissioning photography or specialist illustrations; providing diagnostic research; providing a scope and developing a detailed plan; providing executive coaching and additional alignment activity; and/or providing a role play workshop.

10. The method of claim 8, wherein the aligning and engaging leader users and bringing the story to life includes at least one of: researching and writing up initial stories and/or proof points; coaching a senior leader user in bringing the story to life; adapting and making a connection toolkit; adapting a storywall toolkit; providing a lead facilitator and an advisor at an event; briefing and preparing client facilitators; providing artwork for standard event tools; creating a masterplan in a standard format; producing inspiring multi-media story content; coaching multiple leader users in bringing the story to life; making a connection tool; designing bespoke making a connection toolkit; designing bespoke storywall toolkit; providing multiple facilitators; designing and producing bespoke event tools or an event itself; and/or creating an event masterplan.

11. The method of claim 8, wherein the aligning and engaging additional users, making the connection, and replicating the connection includes at least one of: providing leader users with a cascade planning guide; providing basic instruction at a leader user event plus a guide; providing bringing a story to life toolkit to leader users; providing standard size storymap tools; providing basic instruction at a leader users event plus a guide; providing making a connection toolkit to leader users; providing a workshop with leader users to develop a cascade plan; providing additional workshops and/or training for leader users; providing local language translations; producing employee collateral; producing inspiring multi-media story content; supporting leader users in planning and running an event; providing bespoke size storymap tools; capturing results on a storyweb; facilitating meetings or training internal facilitators; and/or providing additional training on holding connection conversation.

12. The method of claim 8, wherein the building the story and turning the story into action includes at least one of: providing leader users with a storywall toolkit; providing basic instruction at a leader users event plus a guide; providing an initial bank of illustrative stories; aligning workshops with regional and/or functional leader users; facilitating campfire review meetings; providing additional workshops and/or training for leader users; producing inspiring multi-media story content for local leader users; providing ongoing springboard stories for leader users; providing change management intervention; providing systems and process development intervention; and/or providing leadership development intervention.

13. The method of claim 8, wherein the reinforcing the connection includes at least one of: adapting a standard story catalogue; developing a masterplan for capture and share campaign; providing standard story catalogue tools; initializing a storyweb for leader users plus a guide; producing bespoke story catalogue; producing inspiring multi-media story content; providing story research; providing bespoke story catalogue tools; providing training on storytelling for leader users; providing training on storyweb and catalogue tools; and/or designing and facilitating story events.

14. The method of claim 8, wherein the learning and adjusting the story includes at least one of: creating a living story with core SLT; adapting a visual connection; creating a high level masterplan; aligning senior leader users to a program plan; aligning senior leader users to the story; defining story components; consulting with a wider stakeholder group; focussing groups with leader users and additional users on a living story; commissioning photography or specialist illustrations; providing diagnostics research; providing a scope and developing a detailed plan; providing executive coaching and additional alignment activity; and/or providing a role play workshop.

15. The method of claim 8, wherein the story has at least one level of scope including at least one of:
a first level story which is created by a user answering a predetermined number of questions and answers to the questions being linked together in a series with pre-defined sentences to achieve a basic story, wherein the answers to the questions form a content of the story,
a second level story which is created by client administrator users and/or system administrator users further developing a first level story by editing any field of the first level story and adding additional material to a main story text field of a story, and/or
a third level story which is a second level story which a received further refinement and has related files and/or resources associated with the story, wherein the files include at least one of: a PDF document, a PowerPoint presentation, a MPEG video file, and/or a MP3 audio file, and wherein each of the files includes at least one of: title, brief description, file type, filename, and/or file path or file location.
